(19) United States
(12) Patent Application Publication
(10) Pub. No.: US 2025/0010322 A1
(43) Pub. Date: Jan. 9, 2025

(54) SUBSTRATE PROCESSING SYSTEM AND DECOMPRESSION STRUCTURE

(71) Applicant: EBARA CORPORATION, Tokyo (JP)

(72) Inventor: Tomoatsu ISHIBASHI, Tokyo (JP)

(21) Appl. No.: 18/759,451

(22) Filed: Jun. 28, 2024

(30) Foreign Application Priority Data
Jul. 7, 2023 (JP) 2023-111943

(51) Int. Cl. B05B 12/14; B05B 1/06; B05B 7/26

(52) U.S. Cl. CPC B05B 12/1436; B05B 1/06; B05B 7/267

(57) ABSTRACT

A substrate processing system capable of supplying a gas-dissolved liquid having a supersaturated amount of dissolved gas without generating large bubbles in a middle of a supply line is disclosed. The substrate processing system includes a control device configured to control an operation of a bubble generation device. The control device is configured to control at least one of a pressure regulator and a boost pump so that a pressure of a gas supplied to a gas-dissolved liquid generation device is smaller than a pressure of a liquid supplied to the gas-dissolved liquid generation device.

### CROSS REFERENCE TO RELATED APPLICATION

This document claims priority to Japanese Patent Application No. 2023-111943 filed Jul. 7, 2023, the entire contents of which are hereby incorporated by reference.

### BACKGROUND

In recent years, with the miniaturization of semiconductor devices, various material films with different physical properties are formed on a substrate and then processed. In particular, in a damascene wiring formation process in which wiring grooves formed in a substrate are filled with metal, after the damascene wiring is formed, excess metal is removed by polishing using a polishing apparatus (CMP apparatus).

By removing excess metal, films with different wettability to water, such as metal films, barrier films, and insulating films, are present on a surface of the substrate. Residues of the polishing liquid (slurry) used in a CMP polishing and polishing debris adhere to a surface of such films. If the surface of the film has a complex shape that is difficult to clean, if it is not cleaned sufficiently, the adhesion may cause leaks or cause poor adhesion, which may cause reliability problems.

As a method for effectively cleaning the surface of the substrate, there is a method of supplying a liquid containing bubbles to the surface of the substrate (see, for example, JP 2020-174081 A). Such a liquid is generated by dissolving a gas in the liquid until the liquid becomes supersaturated.

However, due to a pressure loss occurring in the supply line within the apparatus, the pressure of the liquid drops, making it difficult to supply the liquid with a supersaturated amount of dissolved gas. Because the amount of dissolved gas in the liquid is small, the amount of bubbles that affect the cleaning effect is small and the size of the bubbles is large. As a result, there is a risk that the surface of the substrate cannot be effectively cleaned.

### SUMMARY

Therefore, there is provided a substrate processing system capable of supplying a gas-dissolved liquid having a supersaturated amount of dissolved gas without generating large bubbles in a middle of a supply line.

The supply line for supplying the gas-dissolved liquid becomes easily charged with electricity. In particular, a decompression structure that generates bubbles may be attached to the supply line. In this case, an electric discharge is likely to occur in a narrow liquid flow passage of the decompression structure, and the electric discharge may damage the decompression structure. As a result, particles may be generated due to fragments of the decompression structure, and an efficiency of bubble generation may decrease.

Therefore, there is provided a decompression structure capable of preventing damage caused by an electric discharge.

Embodiments, which will be described below, relate to a substrate processing system and a decompression structure.

In an embodiment, there is provided a substrate processing system comprising: a substrate processing module configured to process a substrate; a bubble generation device configured to generate bubbles from a gas-dissolved liquid supplied to the substrate processing module; and a control device configured to control an operation of the bubble generation device. The substrate processing module comprises a supply nozzle configured to supply the gas-dissolved liquid, the bubble generation device comprises: a supply line connected to the supply nozzle; a boost pump configured to boost a pressure of a liquid flowing through the supply line; a gas-dissolved liquid generation device configured to dissolve a gas in the liquid flowing through the supply line to a supersaturated state; a pressure regulator configured to regulate a pressure of the gas supplied to the gas-dissolved liquid generation device; and a decompression structure configured to generate ultra-fine bubbles from the gas-dissolved liquid generated by the gas-dissolved liquid generation device, and the control device is configured to control at least one of the pressure regulator and the boost pump so that the pressure of the gas supplied to the gas-dissolved liquid generation device is smaller than the pressure of the liquid supplied to the gas-dissolved liquid generation device.

In an embodiment, the decompression structure has: a liquid inlet surface through which the gas-dissolved liquid flows in; a liquid outlet surface through which the gas-dissolved liquid flows out; and a liquid throttle surface arranged between the liquid inlet surface and the liquid outlet surface, and each of cross-sectional areas of the liquid inlet surface and the liquid outlet surface is larger than a cross-sectional area of the liquid throttle surface.

In an embodiment, the decompression structure is made of a grounded conductive resin.

In an embodiment, the decompression structure comprises a decompression membrane configured to reduce a pressure of the gas-dissolved liquid.

In an embodiment, the supply line has: an upstream portion arranged upstream of the decompression structure in a flow direction of the gas-dissolved liquid; and a downstream portion arranged downstream of the decompression structure, and at least one of the upstream portion and the downstream portion is made of a grounded conductive resin.

In an embodiment, in a case in which the decompression structure is defined as a first decompression structure, the bubble generation device comprises a second decompression structure configured to generate microbubbles from the gas-dissolved liquid generated by the gas-dissolved liquid generation device.

In an embodiment, the supply line has a first bypass line and a second bypass line arranged in a middle of the supply line; the first decompression structure is connected to the first bypass line; and the second decompression structure is connected to the second bypass line.

In an embodiment, in a case in which the supply nozzle is defined as a first supply nozzle, the substrate processing module comprises: the first supply nozzle; and a second supply nozzle configured to supply the gas-dissolved liquid. The supply line has: a first branch line connected to the first supply nozzle; and a second branch line connected to the second supply nozzle, the first decompression structure is connected to the first branch line, and the second decompression structure is connected to the second branch line.

In an embodiment, there is provided a decompression structure applicable to a bubble generation device for generating bubbles from a gas-dissolved liquid supplied to a substrate processing module, comprising: the decompression structure has: a main body portion connected to a supply line through which the gas-dissolved liquid flows; and a wall portion attached to the main body portion and having an opening, and the wall portion is made of a grounded conductive resin.

In an embodiment, the main body portion is made of a conductive resin and is an integrally molded member with the wall portion.

In an embodiment, the opening is formed in a central portion of the wall portion.

In an embodiment, the opening is formed in a connection portion of the wall portion with the main body portion.

In an embodiment, the wall portion has a protrusion formed in a central portion of the wall portion, and the protrusion extends parallel to the main body portion.

In an embodiment, the protrusion has a cylindrical shape.

In an embodiment, the protrusion has a conical shape.

The control device is configured to make the pressure of the gas supplied to the gas-dissolved liquid generation device smaller than the pressure of the liquid supplied to the gas-dissolved liquid generation device. With this configuration, the substrate processing system can supply the gas-dissolved liquid having a supersaturated amount of dissolved gas without generating large bubbles in the middle of the supply line.

The decompression structure has the wall portion made of a grounded conductive resin. With this configuration, it is possible to prevent the wall portion of the decompression structure from being charged with electricity. Therefore, it is possible to prevent the decompression structure from being damaged due to the electric discharge.

### BRIEF DESCRIPTION OF THE DRAWINGS

FIG. 1 is a view showing a substrate processing system;

FIG. 2 is a schematic view of the substrate processing system;

FIG. 3 is a view showing a polishing module;

FIG. 4 is a view showing a first cleaning module;

FIG. 5 is a view showing a second cleaning module;

FIG. 6 is a view showing a bubble generation device;

FIGS. 7A and 7B are views showing an embodiment of a decompression structure;

FIG. 8 is a view showing another embodiment of the decompression structure;

FIG. 9 is a view showing a gas-dissolved liquid supplied to substrate processing modules;

FIG. 10 is a view showing another embodiment of the bubble generation device;

FIG. 11 is a view showing another embodiment of the bubble generation device;

FIG. 12 is a view showing another embodiment of the decompression structure;

FIGS. 13A and 13B are views showing another embodiment of the decompression structure;

FIGS. 14A and 14B are views showing an arrangement of an opening in a wall portion;

FIG. 15A is a view showing another embodiment of the decompression structure, FIG. 15B is a view showing an arrangement of the opening in the wall portion, and FIG. 15C is a view showing another embodiment of the decompression structure;

FIG. 16 is a graph showing a cleaning effect of ultra-fine bubbles;

FIG. 17 is a view showing a cleaning module including a buff cleaning member; and

FIG. 18 is a view showing a drying module.

### DESCRIPTION OF EMBODIMENTS

Hereinafter, the embodiments will be described with reference to the drawings. In the drawings described below, the same or corresponding components are denoted by the same reference numerals, and duplicated descriptions will be omitted. In the multiple embodiments described below, the configuration of one embodiment that is not particularly described is the same as the other embodiments, so duplicated descriptions will be omitted.

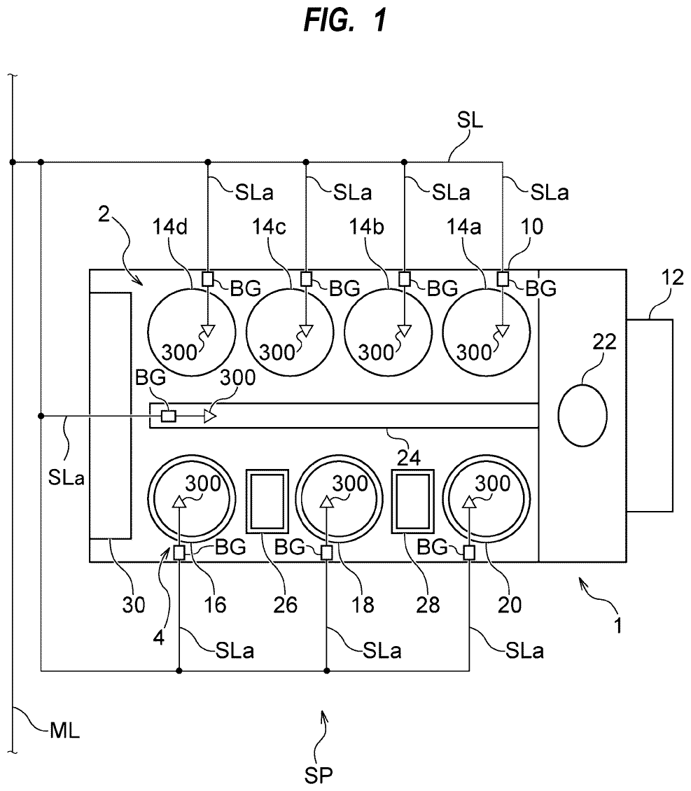

FIG. 1 is a view showing a substrate processing system. As shown in FIG. 1, the substrate processing system SP includes a substrate processing apparatus 1 and a supply line SL that supplies a liquid to the substrate processing apparatus 1. The substrate processing apparatus 1 includes a housing 10 and a load port 12 on which a substrate cassette that stocks a large number of wafers is placed. The load port 12 is arranged adjacent to the housing 10. The wafer is, for example, a semiconductor wafer, and is an example of a substrate.

The substrate processing apparatus 1 includes a polishing unit 2 and a cleaning unit 4 arranged inside the housing 10. The polishing unit 2 includes a plurality of (four in this embodiment) polishing modules 14a to 14d. The cleaning unit 4 includes a first cleaning module 16 and a second cleaning module 18 that clean the polished substrate, and a drying module 20 that dries the cleaned substrate.

The polishing modules 14a to 14d are arranged along a longitudinal direction of the substrate processing apparatus 1. Similarly, the first cleaning module 16, the second cleaning module 18, and the drying module 20 are arranged along the longitudinal direction of the substrate processing apparatus 1.

In this specification, the polishing modules 14a to 14d, the first cleaning module 16, the second cleaning module 18, and the drying module 20 are collectively referred to as a substrate processing module for processing the substrate.

The substrate processing apparatus 1 includes a first transport robot 22 arranged adjacent to the load port 12, and a transport module 24 arranged adjacent to the polishing modules 14a to 14d. The first transport robot 22 receives the substrate before polishing from the load port 12 and transfers it to the transport module 24, and receives the dried substrate from the drying module 20 and returns it to the load port 12. The transport module 24 transports the substrate received from the first transport robot 22, and transfers the substrate between each of the polishing modules 14a to 14d.

The substrate processing apparatus 1 includes a second transfer robot 26 arranged between the first cleaning module 16 and the second cleaning module 18, and a third transfer robot 28 arranged between the second cleaning module 18 and the drying module 20. The second transfer robot 26 transfers the substrate between the transfer module 24 and each of the cleaning modules 16 and 18. The third transfer robot 28 transfers the substrate between each of the modules 18 and 20.

The substrate processing system SP includes a control device 30 arranged inside the housing 10. The control device 30 is configured to control an operation of each device of the substrate processing system SP.

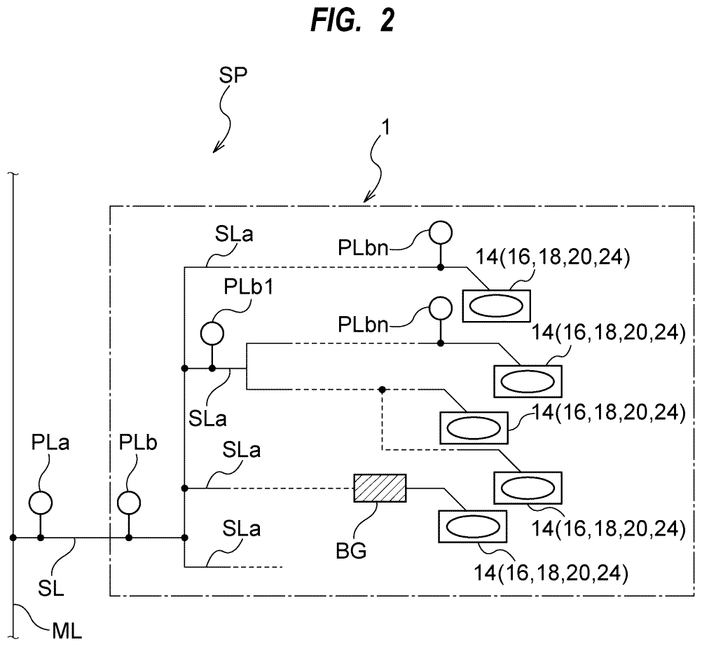

FIG. 2 is a schematic view of the substrate processing system. The substrate processing system SP includes a supply line SL that supplies a liquid (more specifically, a processing liquid) to the substrate processing module. The supply line SL is connected to a main line ML that supplies the liquid to equipment in a factory. The main line ML is a utility line installed in the factory.

The supply line SL has a plurality of distribution supply lines SLa which are connected to each of the substrate processing modules (more specifically, the polishing modules 14a to 14d, the first cleaning module 16, the second cleaning module 18, the drying module 20, and the transfer module 24). The liquid flowing through the main line ML is supplied to each of the substrate processing modules through the supply line SL and the distribution supply lines SLa.

Pressure sensors PLa and PLb for detecting the pressure of the liquid flowing through the supply line SL are connected to the supply line SL. The pressure sensor PLa is arranged outside the substrate processing apparatus 1, and the pressure sensor PLb is arranged inside the substrate processing apparatus 1. A pressure sensor PLb1 for detecting the pressure of the liquid flowing through the distribution supply line SLa is connected to the distribution supply line SLa. A pressure sensor PLbn is connected to a line branching off from the distribution supply line SLa.

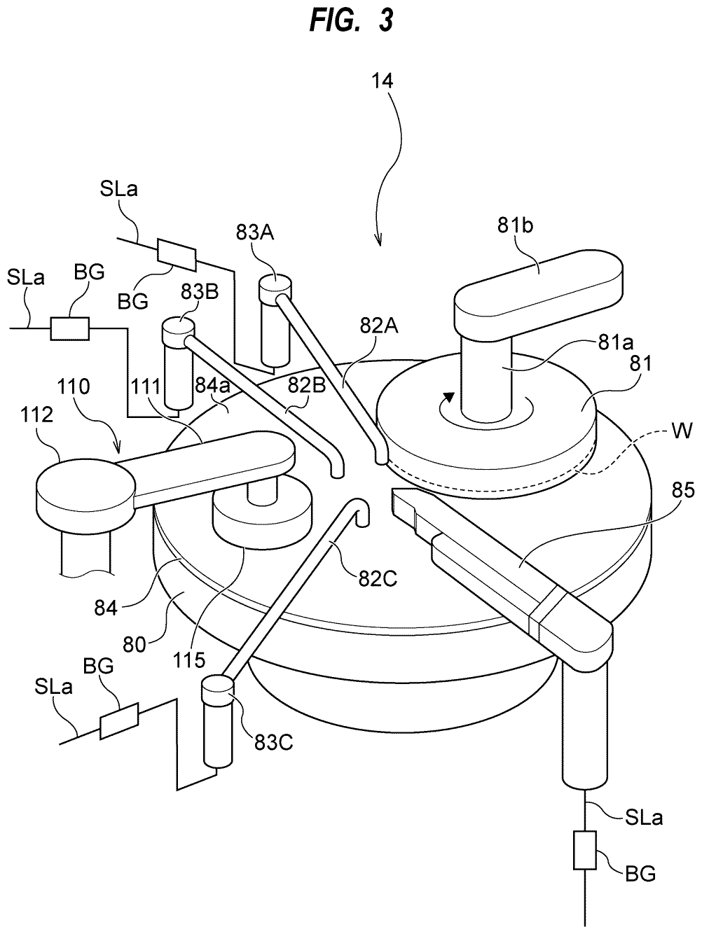

FIG. 3 is a view showing the polishing module. In the embodiment described below, the polishing modules 14a to 14d may be collectively referred to as the polishing module 14. The polishing module 14 includes a polishing table 80 that supports a polishing pad 84 having a polishing surface 84a, a substrate holding mechanism (top ring) 81 that holds the wafer W and presses it against the polishing surface 84a, and a supply nozzle (slurry supply nozzle in this embodiment) 82A that supplies a slurry (polishing liquid) to the polishing surface 84a.

The polishing module 14 includes a supply nozzle (in this embodiment, a pure water supply nozzle) 82B for supplying pure water onto the polishing surface 84a, a supply nozzle (in this embodiment, a chemical liquid supply nozzle) 82C for supplying a chemical liquid to the polishing surface 84a, and a supply nozzle (in this embodiment, a pure water supply nozzle) 85 for supplying pure water for removing the slurry adhering to the polishing surface 84a. In other words, the pure water supply nozzle 85 is an atomizer. Therefore, hereinafter, the pure water supply nozzle 85 may be referred to as an atomizer 85.

In the embodiment shown in FIG. 3, the polishing module 14 includes a plurality of supply nozzles 82A, 82B, and 82C, but in one embodiment, the polishing module 14 may include a single supply nozzle that selectively supplies any one of the liquids, slurry, pure water, and chemical liquid, instead of the supply nozzles 82A, 82B, and 82C.

The polishing module 14 includes a dressing device 110 for dressing the polishing pad 84. The dressing device 110 includes a dresser 115 that is in sliding contact with the polishing surface 84a of the polishing pad 84, a dresser arm 111 that supports the dresser 115, and a dresser pivot shaft 112 that pivots the dresser arm 111. The dresser pivot shaft 112 is arranged outside the polishing pad 84.

The dresser 115 oscillates on the polishing surface 84a as the dresser arm 111 swivels. A lower surface of the dresser 115 constitutes a dressing surface made of a large number of abrasive grains such as diamond particles. The dresser 115 rotates while oscillating on the polishing surface, and dresses the polishing surface by slightly scraping off the polishing pad 84.

The polishing table 80 is formed in a disk shape and is configured to be rotatable about its central axis as an axis of rotation. The polishing pad 84 is attached to the upper surface of the polishing table 80. When the polishing table 80 is rotated by a motor (not shown), the polishing pad 84 rotates integrally with the polishing table 80.

The top ring 81 holds the wafer W on its lower surface by vacuum suction or the like. The top ring 81 is configured to be rotatable together with the wafer W by power from a motor (not shown). An upper portion of the top ring 81 is connected to a support arm 81b via a shaft 81a.

The top ring 81 can be moved up and down by an air cylinder (not shown) to adjust a distance between the top ring 81 and the polishing table 80. With this configuration, the top ring 81 presses the held wafer W against the polishing surface 84a of the polishing pad 84.

The support arm 81b is configured to oscillate by a motor (not shown) and moves the top ring 81 in a direction parallel to the polishing surface 84a. In this embodiment, the top ring 81 is configured to be movable between a receiving position for the wafer W (not shown) and a position above the polishing pad 84, and a position at which the wafer W is pressed against the polishing pad 84 can be changed.

The slurry supply nozzle 82A is provided above the polishing table 80, and supplies the slurry onto the polishing pad 84. The slurry supply nozzle 82A is supported by a shaft 83A. The shaft 83A is configured to be movable by a motor (not shown). Therefore, the slurry supply nozzle 82A can change a position at which the slurry is dropped around the shaft 83A during a polishing process of the wafer W. In this manner, the slurry supply nozzle 82A supplies the slurry so that it penetrates into a contact interface between the rotating wafer W and the polishing pad 84.

The pure water supply nozzle 82B is provided above the polishing table 80 and supplies pure water onto the polishing pad 84. The pure water supply nozzle 82B is supported by a shaft 83B. Similarly, the chemical liquid supply nozzle 82C is provided above the polishing table 80 and supplies the chemical liquid onto the polishing pad 84. The chemical liquid supply nozzle 82C is supported by a shaft 83C. These shafts 83B and 83C are configured to be movable by a motor (not shown).

The atomizer 85 is provided above the polishing table 80 and extends along a radial direction of the polishing table 80. Immediately after the polishing process of the wafer W with the slurry, the atomizer 85 sprays a cleaning fluid at a predetermined flow rate toward the polishing pad 84 to wash away a part of the slurry adhering to the polishing surface 84a and the wafer W. The cleaning fluid is composed of a mixed fluid of a liquid (usually pure water) and a gas (e.g., an inert gas such as nitrogen gas).

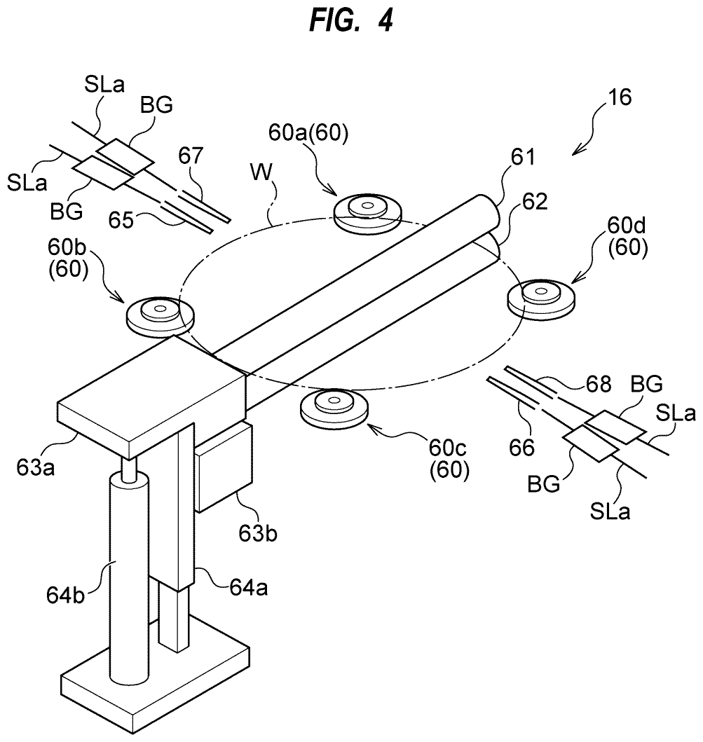

FIG. 4 is a view showing the first cleaning module. As shown in FIG. 4, the first cleaning module 16 includes a substrate holding mechanism 60 that holds and rotates the wafer W, cleaning members 61 and 62 that come into contact with the wafer W to scrub the wafer W, supply nozzles (chemical liquid supply nozzles in this embodiment) 65 and 66 that supply a processing liquid (diluted chemical liquid in this embodiment) toward front and back surfaces of the wafer W, and supply nozzles (pure water supply nozzles in this embodiment) 67 and 68 that supply a processing liquid (pure water in this embodiment) toward the front and back surfaces of the wafer W.

Each of the cleaning members 61 and 62 is a sponge member having a cylindrical shape and a longitudinal length longer than a diameter of the wafer W. The sponge member is preferably made of a highly hydrophilic material, such as PU (polyurethane) or PVAc (polyvinyl acetal).

Each of the cleaning members 61 and 62 is arranged such that a direction of its central axis is parallel to the surface (i.e., the front and back surfaces) of the wafer W. Hereinafter, the cleaning member 61 may be referred to as an upper roll cleaning member 61, and the cleaning member 62 may be referred to as a lower roll cleaning member 62.

The substrate holding mechanism 60 includes four rollers 60a to 60d that horizontally hold and rotate the wafer W with the front surface of the wafer W facing upward. The rollers 60a to 60d are configured to be movable in directions approaching and separating from each other by a drive mechanism (e.g., an air cylinder) not shown.

In this embodiment, the substrate holding mechanism 60 includes rollers 60a to 60d as its components, but the substrate holding mechanism 60 is not limited to the rollers as long as it can hold a side surface of the wafer W. Instead of the rollers, the substrate holding mechanism 60 may include, for example, a plurality of clamps (not shown). The clamps are configured to be movable between a position for holding a peripheral portion of the wafer W and a position spaced apart from the wafer W.

The upper roll cleaning member 61 and the lower roll cleaning member 62 are supported by lifting mechanisms 64a and 64b, respectively, and can be moved up and down by the lifting mechanisms 64a and 64b. Each of the lifting mechanisms 64a and 64b may include a motor drive mechanism using a ball screw or an air cylinder.

The upper roll cleaning member 61 and the lower roll cleaning member 62 are spaced apart from each other when transporting the wafer W in and out. When cleaning the wafer W, the upper roll cleaning member 61 and the lower roll cleaning member 62 move in directions approaching each other to come into contact with the front and back surfaces of the wafer W. Thereafter, the upper roll cleaning member 61 and the lower roll cleaning member 62 are rotated by rotation mechanisms 63a and 63b, respectively, to scrub the wafer W (scrub cleaning).

In this manner, when the upper roll cleaning member 61 and the lower roll cleaning member 62 are scrubbing the wafer W, the first cleaning module 16 supplies the chemical liquid onto the front and back surfaces of the wafer W through the chemical liquid supply nozzles 65 and 66.

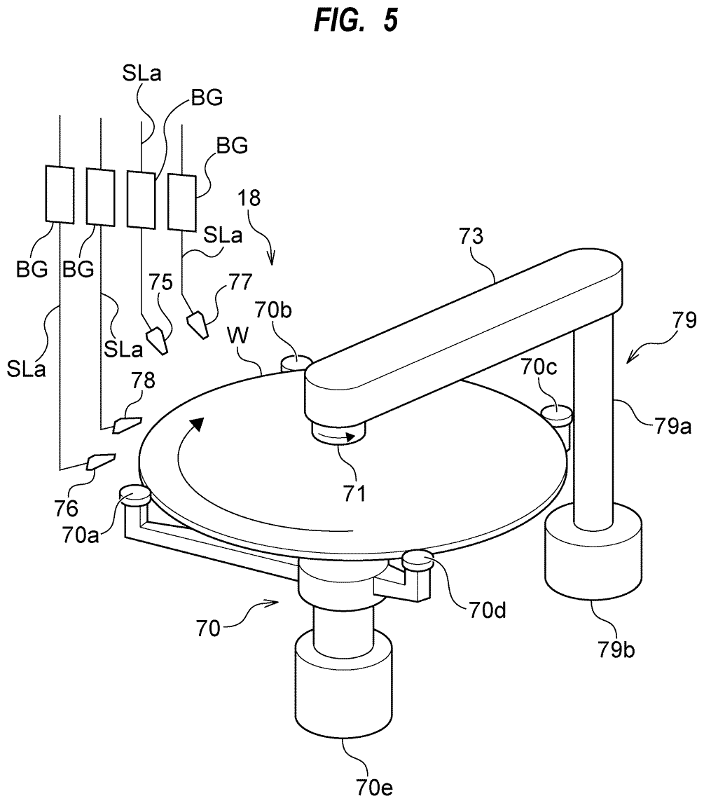

FIG. 5 is a view showing the second cleaning module. As shown in FIG. 5, the second cleaning module 18 includes a substrate holding mechanism 70 that holds and rotates the wafer W, a cleaning member 71 that comes into contact with the wafer W to scrub the wafer W, an arm 73 coupled to the cleaning member 71, an arm oscillation mechanism 79 that oscillates the arm 73 in a horizontal direction, supply nozzles (chemical liquid supply nozzles in this embodiment) 75 and 76 that supplies a processing liquid (diluted chemical in this embodiment) toward the front and back surfaces of the wafer W, and supply nozzles (pure water supply nozzles in this embodiment) 77 and 78 that supplies a processing liquid (pure water in this embodiment) toward the front and back surfaces of the wafer W.

The substrate holding mechanism 70 includes chucks 70a to 70d that holds the peripheral portion of the wafer W, and a motor 70e coupled to the chucks 70a to 70d. The chucks 70a to 70d hold the wafer W and rotate the wafer W about its axis by driving the motor 70c.

The cleaning member 71 is a sponge member having a pencil shape, and rotating around the central axis of the cleaning member 71, contacting the surface of the wafer W and scrubbing the wafer W. Hereinafter, the cleaning member 71 may be referred to as a pencil cleaning member 71. The arm 73 is arranged above the wafer W and is coupled to an arm swinging mechanism 79.

The arm swinging mechanism 79 includes a pivot shaft 79a and a rotation mechanism 79b. One end of the arm 73 is coupled to the pivot shaft 79a, and the other end of the arm 73 is coupled to the pencil cleaning member 71. A direction of the central axis of the pencil cleaning member 71 is perpendicular to the front surface (or back surface) of the wafer W.

The rotation mechanism 79b that swivels the arm 73 is coupled to the rotation shaft 79a. The rotation mechanism 79b is configured to swivel the arm 73 within a plane parallel to the wafer W by rotating the rotation shaft 79a.

The pencil cleaning member 71 moves in a radial direction of the wafer W by swiveling the arm 73. The pivot shaft 79a can be moved in a vertical direction by a lifting mechanism (not shown), and the pencil cleaning member 71 is pressed against the front surface of the wafer W with a predetermined pressure to scrub the wafer W (scrub cleaning). The lifting mechanism may include a motor-driven mechanism using a ball screw or an air cylinder.

In this manner, when the pencil cleaning member 71 is scrubbing the wafer W, the second cleaning module 18 supplies the chemical liquid onto the front and back surfaces of the wafer W through the chemical liquid supply nozzles 75 and 76.

Hereinafter, in this specification, for convenience of explanation, the supply nozzles 82A to 82C, 85, 65, 66, 67, 68, 75, 76, 77, and 78 may be collectively referred to as a supply nozzle 300. The supply nozzle 300 is a nozzle for supplying the liquid, and is not necessarily limited to the supply nozzles 82A to 82C, 85, 65, 66, 67, 68, 75, 76, 77, and 78 described above.

In order to efficiently process the surface (i.e., the front and back surfaces) of the wafer W, it is desirable to supply a gas-dissolved liquid containing a high concentration of bubbles (more specifically, ultra-fine bubbles) from the supply nozzle onto the surface of the wafer W. Note that the ultra-fine bubble is minute bubbles having a bubble diameter of 1 micrometer or less.

In order to generate a gas-dissolved liquid containing a high concentration of the ultra-fine bubbles, it is necessary to generate the gas-dissolved liquid with a supersaturated amount of dissolved gas by allowing a gas to be absorbed into a liquid until it becomes supersaturated. However, as shown in FIGS. 1 and 2, the liquid supplied from the main line ML is supplied onto the substrate processing module through the supply line SL and the distribution supply line SLa.

Therefore, a pressure loss occurring in these lines ML, SL, and SLa may reduce a pressure of the gas-dissolved liquid, and the amount of dissolved gas in the gas-dissolved liquid may decrease. Therefore, the substrate processing system SP has a configuration capable of supplying the gas-dissolved liquid having a supersaturated amount of dissolved gas.

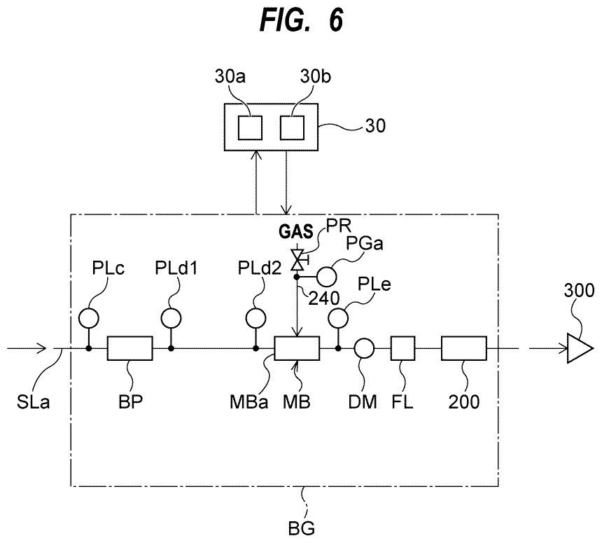

FIG. 6 is a view showing a bubble generation device. The substrate processing system SP includes a bubble generation device BG that generates the gas-dissolved liquid and generates bubbles (more specifically, ultra-fine bubbles) from the gas-dissolved liquid to be supplied to the substrate processing module. The bubble generation device BG that supplies the gas-dissolved liquid to the substrate processing module is, in other words, a gas-dissolved bubble generation liquid supply device.

The bubble generation device BG is arranged inside the substrate processing apparatus 1 (see FIGS. 1 and 2).

As shown in FIG. 6, the bubble generation device BG includes the supply line SL (more specifically, the distribution supply line SLa) connected to the supply nozzle 300, a boost pump BP for boosting the pressure of the liquid flowing through the distribution supply line SLa, a gas-dissolved liquid generation device MB for dissolving gas in the liquid flowing through the distribution supply line SLa to a supersaturated state, a pressure regulator PR for regulating the pressure of the gas supplied to the gas-dissolved liquid generation device MB, and a decompression structure 200 for generating the ultra-fine bubbles from the gas-dissolved liquid generated by the gas-dissolved liquid generation device MB.

The boost pump BP is arranged upstream of the gas-dissolved liquid generation device MB in a flow direction of the liquid flowing through the distribution supply line SLa, and the gas-dissolved liquid generation device MB is arranged upstream of the decompression structure 200.

The bubble generation device BG includes a pressure sensor PLc arranged upstream of the boost pump BP, pressure sensors PLd1 and PLd2 arranged between the boost pump BP and the gas-dissolved liquid generation device MB, and a pressure sensor PLe arranged downstream of the gas-dissolved liquid generation device MB.

The pressure sensor PLd1 is arranged near the boost pump BP, and the pressure sensor PLd2 is arranged near the gas-dissolved liquid generation device MB. In one embodiment, the bubble generation device BG may include either the pressure sensor PLd1 or the pressure sensor PLd2.

In the embodiment shown in FIG. 6, the gas-dissolved liquid generation device MB is a membrane for dissolving gas in the liquid. The gas-dissolved liquid generation device MB includes a generator MBa arranged on a liquid flow passage of the distribution supply line SLa and a gas line 240 connected to the generator MBa. The pressure regulator PR is connected to the gas line 240.

The bubble generation device BG includes a pressure sensor PGa arranged downstream of the pressure regulator PR in a flow direction of the gas. The pressure sensor PGa is configured to detect the pressure of the gas flowing through the gas line 240. In one embodiment, the pressure regulator PR may have the same function as the pressure sensor PGa. In this case, the pressure sensor PGa may be omitted.

The gas supplied to the generator MBa may include, for example, an inert gas (such as nitrogen gas, argon gas), but is not limited to an inert gas. In one embodiment, the gas supplied to the generator MBa may include an active gas (such as carbon dioxide, oxygen, hydrogen).

In the embodiment shown in FIG. 6, the control device 30 is electrically connected to the bubble generation device BG and is configured to control an operation of the bubble generation device BG. The control device 30 is composed of a dedicated computer or a general-purpose computer. The control device 30 includes a memory unit 30a in which programs, data, etc. are stored, and a calculation unit 30b such as a CPU (Central Processing Unit) or a GPU (Graphics Processing Unit) that performs calculations according to the programs stored in the memory unit 30a.

Pressure signals detected by the pressure sensors PLc, PLd1 (and/or pressure sensor PLd2), PLe, and PGa are sent to the control device 30. The pressure signals sent to the control device 30 are stored in the memory unit 30a. The calculation unit 30b controls an operation of the boost pump BP and an operation of the pressure regulator PR based on the pressure signal stored in the memory unit 30a.

In this embodiment, the control device 30 is configured to control at least one of the pressure regulator PR and the boost pump BP so that a pressure Gp of the gas supplied to the gas-dissolved liquid generation device MB is smaller than a pressure Lp of the liquid supplied to the gas-dissolved liquid generation device MB (Gp<Lp).

More specifically, the control device 30 monitors the pressure signal detected by the pressure sensor PLd1 (and/or the pressure sensor PLd2) and the pressure signal detected by the pressure sensor PGa. The memory unit 30a stores data indicating a pressure relationship in which the pressure Gp of the gas is smaller than the pressure Lp of the liquid (i.e., Gp<Lp).

Therefore, the calculation unit 30b operates the pressure regulator PR and/or the boost pump BP so as to satisfy a predetermined pressure relationship. Under a condition where such a pressure relationship is satisfied, the gas-dissolved liquid generation device MB generates the gas-dissolved liquid having a supersaturated amount of dissolved gas.

As for the pressure relationship, it is preferable that the pressure Gp of the gas is as close as possible to the pressure Lp of the liquid. Therefore, the memory unit 30a may store data indicating a pressure relationship in which the pressure Gp of the gas is equal to or higher than the atmospheric pressure and is smaller than the pressure Lp of the liquid (i.e., atmospheric pressure≤Gp<Lp).

According to the present embodiment, the control device 30 is configured to make the pressure Gp of the gas supplied to the gas-dissolved liquid generation device MB smaller than the pressure Lp of the liquid supplied to the gas-dissolved liquid generation device MB. With this configuration, the substrate processing system SP can supply the gas-dissolved liquid having a supersaturated amount of dissolved gas without generating large bubbles in a middle of the distribution supply line SLa. If the pressure Gp of the gas is made larger than the pressure Lp of the liquid, the gas cannot be dissolved in the liquid, and bubbles may be generated in the liquid.

As shown in FIG. 6, the bubble generation device BG arranged inside the substrate processing apparatus 1 is arranged immediately before the supply nozzle 300 (i.e., near a point of use). Therefore, even if the pressure of the gas-dissolved liquid decreases due to pressure loss occurring in the lines ML, SL, and SLa, the gas-dissolved liquid can be boosted to a predetermined pressure by the boost pump BP in the distribution supply line SLa immediately before the supply nozzle 300, and the gas-dissolved liquid having a supersaturated amount of dissolved gas can be generated.

As shown in FIG. 6, the bubble generation device BG may include a dissolved gas amount measurement device DM and a filter FL arranged downstream of the gas-dissolved liquid generation device MB. The dissolved gas amount measurement device DM is configured to measure the amount of gas contained in the gas-dissolved liquid generated by the gas-dissolved liquid generation device MB, and may be, for example, a device manufactured by Hach Ultra.

The dissolved gas amount measurement device DM is electrically connected to the control device 30, and the control device 30 obtains the amount of dissolved gas measured by the dissolved gas amount measurement device DM. Therefore, the control device 30 may control the pressure regulator PR and/or the boost pump BP based on the amount of dissolved gas in the gas-dissolved liquid until the amount of dissolved gas reaches a predetermined amount.

The filter FL is arranged downstream of the dissolved gas amount measurement device DM, in other words, upstream of the decompression structure 200. The filter FL is configured to capture bubbles contained in the gas-dissolved liquid supplied to the decompression structure 200 and particles contained in the gas-dissolved liquid. With this configuration, the filter FL can remove bubbles and particles contained in the gas-dissolved liquid supplied to the decompression structure 200.

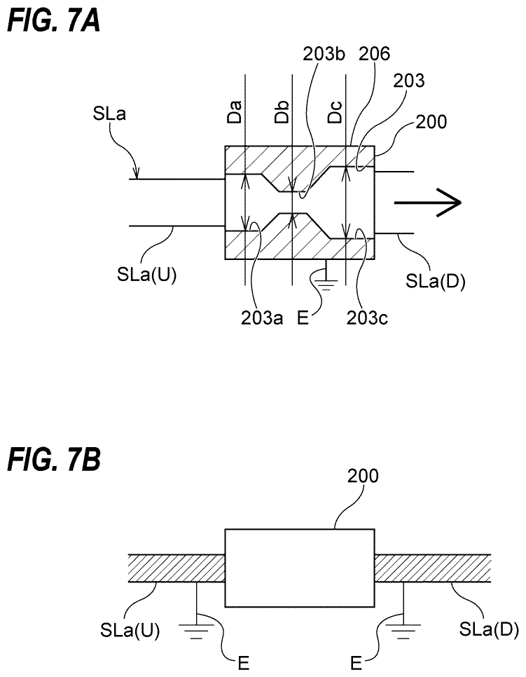

FIGS. 7A and 7B are views showing an embodiment of the decompression structure. As shown in FIG. 7A, the decompression structure 200 has a main body portion 206 connected to the distribution supply line SLa and an inner surface 203 formed on the main body portion 206. The inner surface 203 is in communication with the distribution supply line SLa and has a structure that allows the liquid flowing through the distribution supply line SLa to pass therethrough.

The decompression structure 200 has a liquid inlet surface 203a through which the gas-dissolved liquid flows in, a liquid outlet surface 203c through which the gas-dissolved liquid flows out, and a liquid throttle surface 203b arranged between the liquid inlet surface 203a and the liquid outlet surface 203c.

As shown in FIG. 7A, a cross-sectional area Da of the liquid inlet surface 203a is larger than a cross-sectional area Db of the liquid throttle surface 203b (Da>Db). Similarly, a cross-sectional area Dc of the liquid outlet surface 203c is larger than the cross-sectional area Db of the liquid throttle surface 203b (Dc>Db). A relationship between the cross-sectional areas Da and Dc is not particularly limited, but preferably the cross-sectional area Da is larger than the cross-sectional area Dc (Da>Dc).

The decompression structure 200 having such a structure can rapidly reduce the pressure of the gas-dissolved liquid, and generate the ultra-fine bubbles from the gas-dissolved liquid. More specifically, by making the cross-sectional area Db smaller than the cross-sectional area Da, a flow rate of the gas-dissolved liquid that flows into the liquid throttle surface 203b increases rapidly, and the gas-dissolved liquid is depressurized. As a result, the high concentration of the gas that has been dissolved in the gas-dissolved liquid due to the high pressure is generated as the ultra-fine bubbles from the depressurized gas-dissolved liquid.

In a case in which the decompression structure 200 is made of a resin (e.g., a fluororesin (PTFE, PFA, PVDF, etc.)), when the gas-dissolved liquid passes through the decompression structure 200, the decompression structure 200 is likely to become charged with electricity. In particular, when the gas-dissolved liquid is a liquid with a high specific resistance, such as pure water, the decompression structure 200 is very likely to become charged with electricity.

The decompression structure 200 has a very narrow liquid flow passage (particularly, the liquid throttle surface 203b). Therefore, if the decompression structure 200 is charged with electricity, the electric discharge may occur on the inner surface 203 (particularly, the liquid throttle surface 203b) of the decompression structure 200, which may damage the decompression structure 200. As a result, particles may be generated due to fragments of the decompression structure 200, the ultra-fine bubbles may not be generated appropriately, and the bubble generation efficiency may decrease.

Therefore, the decompression structure 200 is made of a conductive resin that is grounded by an earth E. For example, the decompression structure 200 may be made of a resin that contains carbon nanotubes (CNTs). The decompression structure 200 made of a conductive resin can prevent charging with electricity by the earth E attached to the decompression structure 200. As a result, the damage to the decompression structure 200 caused by the electric discharge can be prevented.

In one embodiment, the control device 30 may be configured to supply an electric current to the decompression structure 200 through the earth E. With such a configuration, the control device 30 can control properties of the gas-dissolved liquid containing the ultra-fine bubbles to generate functional ultra-fine bubbles. For example, the control device 30 can impart a positive charge to the ultra-fine bubbles by supplying the electric current to the decompression structure 200. In this manner, the positively charged ultra-fine bubbles can exhibit high cleaning ability.

As shown in FIG. 7B, the distribution supply line SLa has an upstream portion SLa (U) arranged on the upstream side of the decompression structure 200, and a downstream portion SLa (D) arranged on the downstream side of the decompression structure 200. At least one of the upstream portion SLa (U) and the downstream portion SLa (D) is made of a conductive resin grounded by the earth E. In the embodiment shown in FIG. 7B, both the upstream portion SLa (U) and the downstream portion SLa (D) are made of a conductive resin.

If the distribution supply line SLa is positively charged and the ultra-fine bubbles are negatively charged, the ultra-fine bubbles contained in the gas-dissolved liquid flowing through the downstream portion SLa (D) may adhere to the downstream portion SLa (D).

Therefore, when the downstream portion SLa (D) is made of a grounded conductive resin, charging of the downstream portion SLa (D) can be prevented, thereby suppressing adhesion of the ultra-fine bubbles generated in the decompression structure 200 to the downstream portion SLa (D).

Furthermore, this configuration allows the ultra-fine bubbles and the downstream portion SLa (D) to be given the same type (same sign) of charge. Therefore, the ultra-fine bubbles can flow along a center of the distribution supply line SLa together with the gas-dissolved liquid due to a repulsive force acting on the downstream portion SLa (D). Since the flow of the gas-dissolved liquid along the center of the distribution supply line SLa is relatively fast, the ultra-fine bubbles can be supplied quickly.

By forming the upstream portion SLa (U) from a conductive resin, the risk of the gas-dissolved liquid being charged can be reduced. Therefore, the decompression structure 200 can be prevented from being charged due to the gas-dissolved liquid being charged, and as a result, damage to the decompression structure 200 can be prevented.

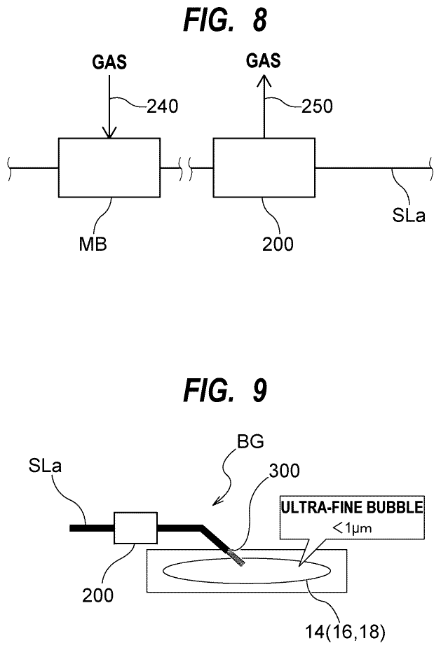

FIG. 8 is a view showing another embodiment of the decompression structure. As shown in FIG. 8, the decompression structure 200 may include a decompression membrane that sucks the gas from the gas-dissolved liquid to reduce the pressure of the gas-dissolved liquid. The decompression structure 200 as the decompression membrane has a suction line 250. The gas-dissolved liquid can be reduced in pressure by sucking gas through the suction line 250.

Although not shown, the embodiment shown in FIG. 8 may be combined with the embodiment shown in FIG. 7B. More specifically, at least one of the upstream portion SLa (U) and the downstream portion SLa (D) arranged on both sides of the decompression structure 200 as the decompression membrane may be made of a conductive resin.

FIG. 9 is a view showing the gas-dissolved liquid supplied to the substrate processing modules. As shown in FIG. 9, the gas-dissolved liquid containing ultra-fine bubbles that has passed through the decompression structure 200 is supplied to the substrate processing modules (more specifically, the polishing modules 14a to 14d, the first cleaning module 16, the second cleaning module 18, and the drying module 20).

For example, when the substrate processing module is the polishing module 14, the slurry supply nozzle 82A may supply the slurry containing ultra-fine bubbles onto the polishing pad 84. In one embodiment, the slurry supply nozzle 82A may supply water (e.g., pure water) containing ultra-fine bubbles instead of the slurry to water-polish the wafer W.

The bubble generation device BG does not need to be installed in all of the substrate processing modules constituting the substrate processing apparatus 1. Therefore, in one embodiment, from the viewpoint of cost reduction, a user can arbitrarily decide to install the bubble generation device BG.

When the bubble generation device BG is connected to the distribution supply line SLa, the atomizer 85 may supply a gas-dissolved liquid containing ultra-fine bubbles onto the polishing pad 84 through the distribution supply line SLa. In one embodiment, the atomizer 85 may supply a gas-dissolved liquid excited by ultrasonic vibration (megasonic liquid).

By supplying a gas-dissolved liquid containing ultra-fine bubbles through the atomizer 85, the slurry and polishing debris can be efficiently removed, and a downtime of the polishing module 14 can be reduced.

For example, when the substrate processing module is the first cleaning module 16, at least one of the chemical liquid supply nozzles 65 and 66 and the pure water supply nozzles 67 and 68 may supply the cleaning liquid (i.e., pure water, chemical liquid) containing ultra-fine bubbles onto the wafer W during cleaning process.

Similarly, when the substrate processing module is the second cleaning module 18, at least one of the chemical liquid supply nozzles 75 and 76 and the pure water supply nozzles 77 and 78 may supply the cleaning liquid (i.e., pure water, chemical liquid) containing ultra-fine bubbles onto the wafer W during cleaning process.

When the ultra-fine bubble contained in the gas-dissolved liquid bursts, an impact of the burst bubbles locally releases energy (light emission, high temperature and pressure, shock waves, etc.). This energy can remove the slurry and polishing debris adhering to the surface of the wafer W and the surface of the polishing pad 84. In addition, since a gas-liquid interface of the gas-dissolved liquid is negatively charged, the gas-dissolved liquid adsorbs and removes positively charged electrolyte ions and dirt.

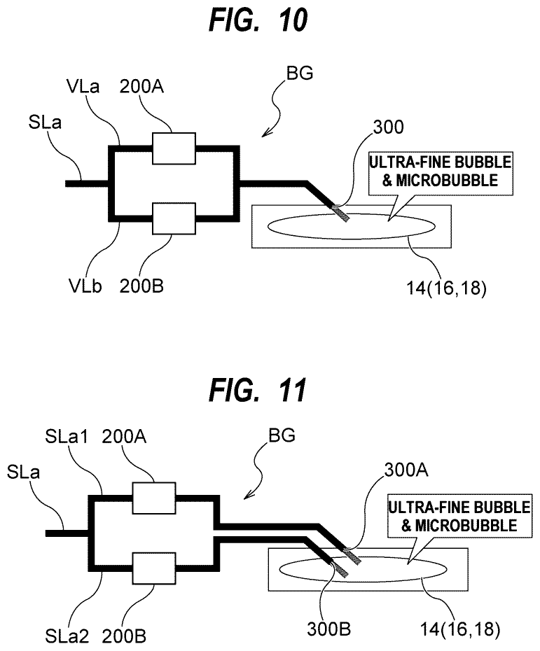

FIG. 10 is a view showing another embodiment of the bubble generation device. As shown in FIG. 10, the bubble generation device BG may include a plurality of decompression structures 200. More specifically, when the decompression structure 200 described with reference to the above-described embodiment is defined as a first decompression structure 200A, the bubble generation device BG may include the first decompression structure 200A and a second decompression structure 200B.

The first decompression structure 200A has a structure for generating ultra-fine bubbles from the gas-dissolved liquid generated by the gas-dissolved liquid generation device MB, while the second decompression structure 200B has a structure for generating microbubbles from the gas-dissolved liquid generated by the gas-dissolved liquid generation device MB. The microbubble is a fine bubble having a bubble diameter of 1 micrometer to 100 micrometers or less.

The second decompression structure 200B may have a structure similar to that of the decompression structure 200 described with reference to FIG. 7A, or may have a structure similar to that of the decompression structure 200 described with reference to FIG. 8. The second decompression structure 200B generates microbubbles by, for example, adjusting a diameter or a size of the opening.

As shown in FIG. 10, the distribution supply line SLa has a first bypass line VLa and a second bypass line VLb arranged in a middle of the distribution supply line SLa. The first decompression structure 200A is connected to the first bypass line VLa, and the second decompression structure 200B is connected to the second bypass line VLb.

The gas-dissolved liquid containing ultra-fine bubbles generated by the first decompression structure 200A passes through the first bypass line VLa and is returned to the distribution supply line SLa. Similarly, the gas-dissolved liquid containing microbubbles generated by the second decompression structure 200B passes through the second bypass line VLb and is returned to the distribution supply line SLa.

In this manner, the gas-dissolved liquid containing ultra-fine bubbles and the gas-dissolved liquid containing microbubbles are mixed in the distribution supply line SLa, and are supplied in this state to the substrate processing module.

FIG. 11 is a view showing another embodiment of the bubble generation device. In the embodiment shown in FIG. 11, the substrate processing module includes a first supply nozzle 300A and a second supply nozzle 300B. The distribution supply line SLa has a first branch line SLa1 connected to the first supply nozzle 300A and a second branch line SLa2 connected to the second supply nozzle 300B.

The first decompression structure 200A is connected to the first branch line SLa1, and the second decompression structure 200B is connected to the second branch line SLa2. With this configuration, it is possible to achieve the same effects as those of the embodiment described with reference to FIG. 10.

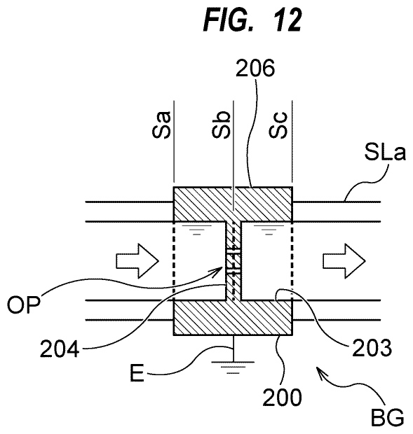

FIG. 12 is a view showing another embodiment of the decompression structure. In the embodiment shown in FIG. 12, the decompression structure 200 further has a wall portion 204 attached to a main body portion 206. The wall portion 204 is arranged to block the flow of the gas-dissolved liquid passing through the main body portion 206 of the decompression structure 200, and has an opening OP. In the embodiment shown in FIG. 12, the wall portion 204 has a plurality of openings OP, but may have a single opening OP.

In this embodiment, a water passage area Sa at a liquid inlet through which the gas-dissolved liquid flows in is larger than a water passage area Sb at the opening OP (Sa>Sb). Similarly, a water passage area Sc at a liquid outlet through which the gas-dissolved liquid flows out is larger than the water passage area Sb (Sc>Sb).

In this embodiment, the decompression structure 200 as a whole has a conductive resin that is grounded by the earth E. In other words, the main body portion 206 is made of a conductive resin and is an integrally molded member with the wall portion 204.

In this embodiment, at least one of the upstream portion SLa (U) and the downstream portion SLa (D) may be made of a conductive resin, as in the embodiment described with reference to FIG. 7B. Such a combination is also applicable to the embodiments described below.

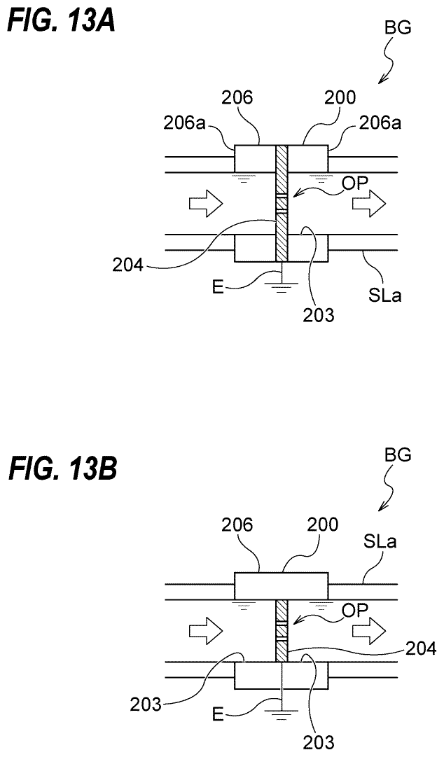

FIGS. 13A and 13B are views showing another embodiment of the decompression structure. In the above-described embodiment, the decompression structure 200 is entirely made of a conductive resin, but as shown in FIGS. 13A and 13B, the decompression structure 200 may have the wall portion 204 made of a conductive resin and grounded to the earth E.

The electric discharge due to charged with electricity is likely to occur in the narrow liquid flow passage of the decompression structure 200. By making the entire decompression structure 200 from a conductive resin, damage due to the electric discharge can be prevented, but a cost of the decompression structure 200 increases. Therefore, in this embodiment, in order to prevent damage due to the electric discharge while reducing the cost of the decompression structure 200, the wall portion 204 of the decompression structure 200, which is the most likely to cause the electric discharge among its components, is made of a conductive resin.

In the embodiment shown in FIG. 13A, the main body portion 206 has two divided bodies 206a, and the wall portion 204 is sandwiched between the two divided bodies 206a. In the embodiment shown in FIG. 13B, the wall portion 204 is incorporated into the main body portion 206. In the embodiment shown in FIGS. 13A and 13B, the control device 30 may be configured to supply a current to the decompression structure 200 through the earth E.

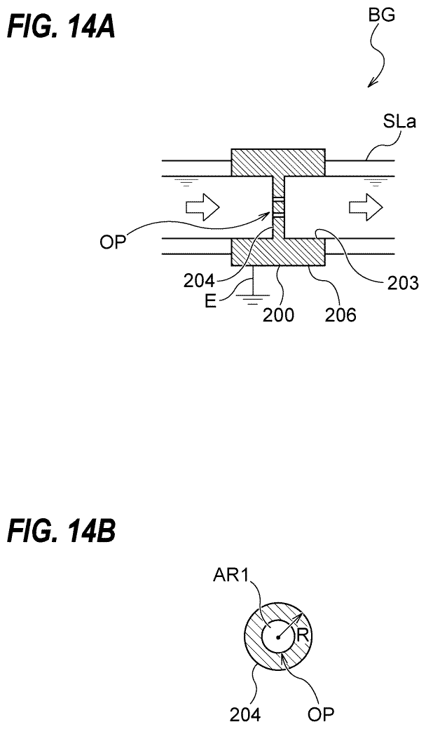

FIGS. 14A and 14B are views showing an arrangement of the opening in the wall portion. The decompression structure 200 according to the embodiment shown in FIG. 14A has the same structure as the decompression structure 200 according to the embodiment described with reference to FIG. 12.

As shown in FIG. 14B, when the wall portion 204 is viewed from the flow direction of the gas-dissolved liquid, the opening OP is formed in a central portion of the wall portion 204. More specifically, the opening OP is arranged in an area AR1 that is ⅓R with respect to a radius R of the wall portion 204 (AR1<⅓R). The wall portion 204 may have a plurality of openings OP in the area AR1.

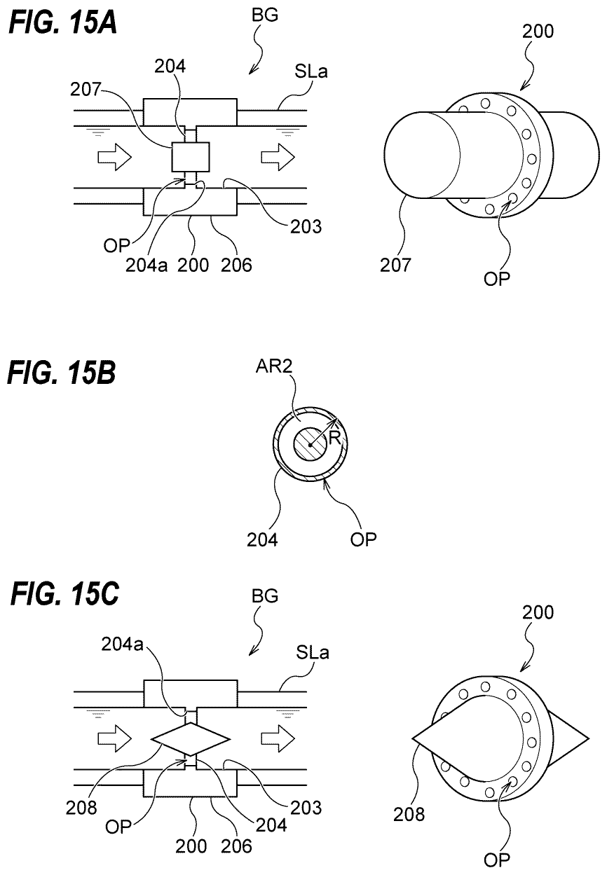

FIG. 15A is a view showing another embodiment of the decompression structure, FIG. 15B is a view showing an arrangement of the opening in the wall portion, and FIG. 15C is a view showing another embodiment of the decompression structure. In the above-described embodiment, the opening OP is formed in the central portion of the wall portion 204, but in the embodiment shown in FIG. 15A, the opening OP is formed in a connection portion 204a of the wall portion 204 with the main body portion 206.

More specifically, the wall portion 204 has a protrusion 207 formed in the central portion of the wall portion 204. The protrusion 207 has a cylindrical shape and extends parallel to the main body portion 206 (i.e., in the flow direction of the gas-dissolved liquid).

As shown in FIG. 15B, when the wall portion 204 is viewed from the flow direction of the gas-dissolved liquid, the opening OP is arranged outside the area of ⅓R with respect to the radius R of the wall portion 204, and is arranged in the area AR2 inside the inner surface 203 of the main body portion 206 (⅓R≤AR2<R). The wall portion 204 may have a plurality of openings OP in the area AR2.

As shown in FIG. 15C, the wall portion 204 may have a protrusion 208 formed in a central portion of the wall portion 204. The protrusion 208 has a conical shape and extends parallel to the main body portion 206.

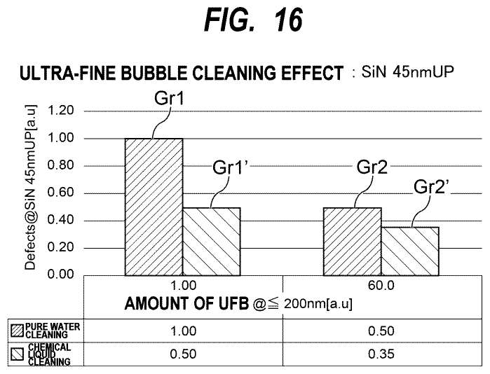

FIG. 16 is a graph showing a cleaning effect of ultra-fine bubbles. In FIG. 16, a graph Gr1 shows the cleaning effect when cleaning with pure water containing almost no ultra-fine bubbles of 200 nanometers or less. A graph Gr1′ shows a cleaning effect when cleaning with a chemical liquid containing almost no ultra-fine bubbles of 200 nanometers or less (more specifically, a diluted chemical liquid obtained by diluting a chemical liquid with pure water).

The amount of ultra-fine bubbles in the graphs Gr1 and Gr1′ is represented by a relative standard value of 1. In the graph Gr1, the number of defects in a silicon nitride (SiN) film when cleaned with pure water is represented by a relative standard value of 1. In the graph Gr1′, the number of defects when cleaned with a chemical liquid can be relatively reduced to 0.5 compared to the graph

### Gr1.

In FIG. 16, the graph Gr2 shows a cleaning effect when cleaned with pure water containing 60 times as many ultra-fine bubbles of 200 nanometers or less as compared to the graph Gr1. The graph Gr2′ shows the cleaning effect when cleaned with a chemical liquid containing 60 times as many ultra-fine bubbles of 200 nanometers or less as compared to the graph Gr1′.

As is clear from the graph Gr2, by increasing the number of ultra-fine bubbles, a cleaning effect (see graph Gr1′) similar to that achieved by the chemical cleaning can be achieved. Furthermore, as shown in the graph Gr2′, by increasing the number of ultra-fine bubbles in chemical liquid cleaning, the cleaning effect can be further improved.

According to this embodiment, the bubble generation device BG generates a gas-dissolved liquid having a supersaturated amount of dissolved gas, and generates a large number of ultra-fine bubbles from the generated gas-dissolved liquid near the use point of the substrate processing module. Therefore, the substrate processing module can clean the wafer W (and the polishing pad 84) with the gas-dissolved liquid having a high cleaning ability (see graphs Gr2 and Gr2′).

In the above-described embodiment, the first cleaning module 16 including the roll cleaning members 61 and 62 and the second cleaning module 18 including the pencil cleaning member 71 are described, but the configurations of the cleaning modules 16 and 18 are not limited to those in the above-described embodiment. In one embodiment, the substrate processing apparatus 1 may include a buff cleaning module as the cleaning modules 16 and 18.

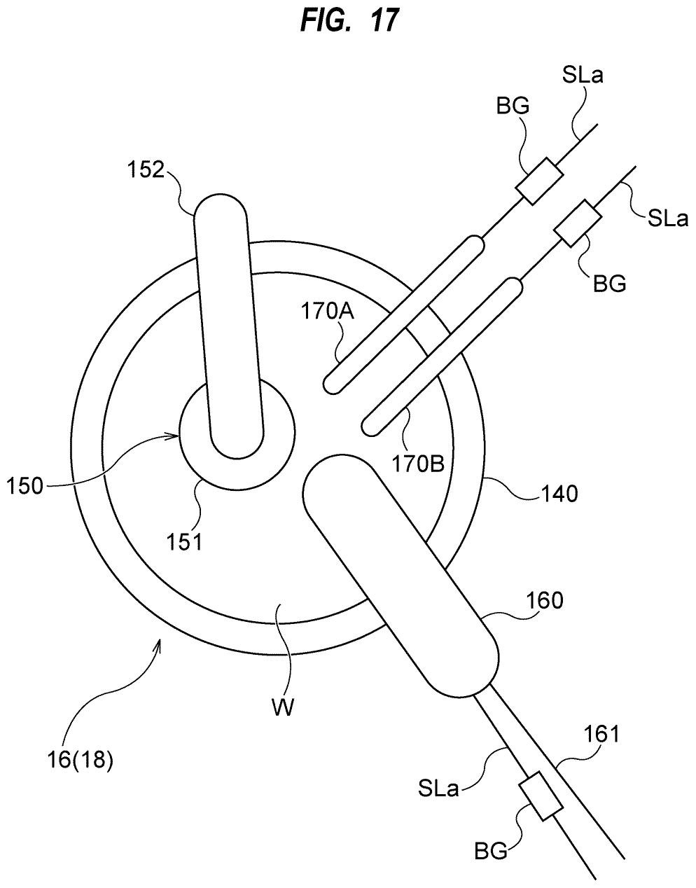

FIG. 17 is a view showing a cleaning module including a buff cleaning member. As shown in FIG. 17, the cleaning module 16 (and/or the cleaning module 18) includes a buff cleaning member 150 that cleans the wafer W while contacting the front surface of the wafer W, and a rotation table 140 that supports the wafer W.

The buff cleaning member 150 includes a buff head 151 that buff cleans the wafer W, and a buff arm 152 that holds the buff head 151. The buff head 151 holds a buff pad (not shown) and is configured to bring the buff pad into contact with the wafer W while rotating the buff pad.

The buff arm 152 is configured to oscillate the buff head 151. When the buff arm 152 oscillates the buff head 151 while the rotation table 140 rotates the wafer W, the wafer W is cleaned as a whole.

In the embodiment shown in FIG. 17, the cleaning module 16 (and/or cleaning module 18) includes a two-fluid nozzle 160 that supplies a mixed fluid of a gas and a liquid onto the front surface of wafer W, and ultrasonic cleaning nozzles 170A and 170B.

As shown in FIG. 17, the two-fluid nozzle 160 is connected to a gas supply line 161 and a distribution supply line SLa, and the bubble generation device BG is connected to the distribution supply line SLa. With this configuration, a mixed fluid of a gas-dissolved liquid containing ultra-fine bubbles and a gas (e.g., nitrogen gas) is supplied from the two-fluid nozzle 160. By supplying such a mixed fluid, the two-fluid nozzle 160 can clean the wafer W with the mixed fluid having high cleaning ability.

Both of the ultrasonic cleaning nozzles 170A and 170B have a vibrator (not shown) and are configured to supply a cleaning liquid (i.e., ultrasonic cleaning liquid) to which ultrasonic waves are applied. For example, the ultrasonic cleaning nozzle 170A is configured to supply the chemical liquid (or pure water) to which ultrasonic waves are applied as the ultrasonic cleaning liquid. Similarly, the ultrasonic cleaning nozzle 170B is configured to supply pure water (or chemical liquid) to which ultrasonic waves are applied as the ultrasonic cleaning liquid.

As shown in FIG. 17, both of the ultrasonic cleaning nozzles 170A and 170B are connected to the distribution supply line SLa, and each of these distribution supply lines SLa is connected to the bubble generation device BG. With this configuration, the gas-dissolved liquid containing ultra-fine bubbles is supplied as an ultrasonic cleaning liquid from each of the ultrasonic cleaning nozzles 170A and 170B. By supplying such an ultrasonic cleaning liquid, each of the ultrasonic cleaning nozzles 170A and 170B can clean the wafer W with a mixed fluid having high cleaning ability.

In the above embodiment, the gas-dissolved liquid is supplied to the polishing module 14 and the cleaning modules 16 and 18 as the substrate processing modules. However, the gas-dissolved liquid may be supplied to the drying module 20.

When a spin rinse dry method is adopted as the drying module 20, in which the wafer W supplied with the cleaning liquid (e.g., pure water) is rotated at high speed to dry it, a gas-dissolved liquid containing ultra-fine bubbles may be supplied to the drying module 20. Similarly, when an IPA gas drying method (i.e., Rotagoni drying) is adopted as the drying module 20, the gas-dissolved liquid containing ultra-fine bubbles may be supplied to the drying module 20.

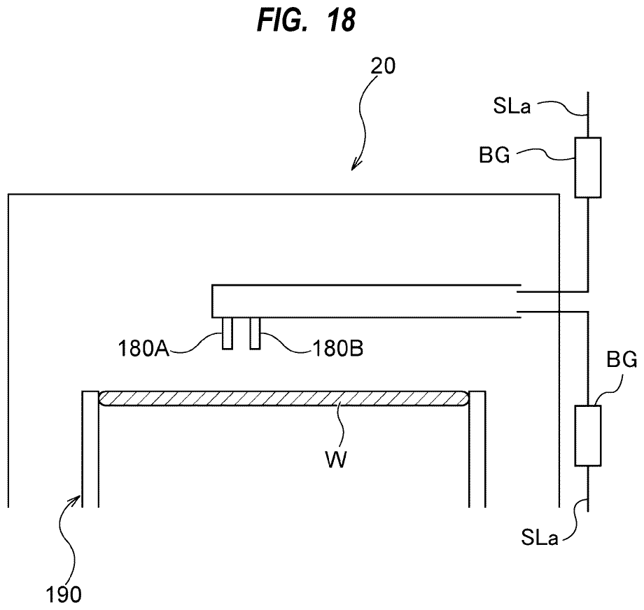

FIG. 18 is a view showing the drying module. In the embodiment shown in FIG. 18, the drying module 20 is configured to perform Rotagoni drying. The drying module 20 includes a wafer supporter 190 that supports the wafer W, and supply nozzles 180A and 180B for performing Rotagoni drying.

In this embodiment, the supply nozzle 180A is a nozzle for supplying IPA vapor (a mixture of isopropyl alcohol and nitrogen gas) onto the front surface of the wafer W supported by the wafer supporter 190. The supply nozzle 180B is a nozzle for supplying pure water onto the front surface of the wafer W supported by the wafer supporter 190. Pure water supplied from the supply nozzle 180B is intended to prevent the front surface of the wafer W from drying.

When drying the wafer W, the wafer supporter 190 rotates the wafer W, while the supply nozzles 180A and 180B supply IPA vapor and pure water, respectively, toward the front surface of the rotating wafer W. Both the supply nozzles 180A and 180B are connected to the distribution supply line SLa, and each of these distribution supply lines SLa is connected to the bubble generation device BG. With this configuration, IPA vapor containing ultra-fine bubbles and pure water containing ultra-fine bubbles are supplied from each of the supply nozzles 180A and 180B.

Note that the two-fluid nozzle 160, the ultrasonic cleaning nozzles 170A and 170B, and the supply nozzles 180A and 180B in the embodiment shown in FIGS. 17 and 18 all constitute the supply nozzle 300 according to the above-described embodiment.

In the above-described embodiment, the polishing modules 14a to 14d, the first cleaning module 16, the second cleaning module 18, and the drying module 20 are exemplified as the substrate processing modules, but the substrate processing module may include the transfer module 24. Even in this case, the bubble generation device BG can generate a large number of ultra-fine bubbles from the generated gas-dissolved liquid near the use point of the transfer module 24 serving as the substrate processing module (see FIG. 1).

The gas-dissolved liquid containing ultra-fine bubbles is supplied toward the transfer module 24 from the supply nozzle 300 arranged adjacent to the transfer module 24. With this configuration, the transfer module 24 can be cleaned with high cleaning ability.

The previous description of embodiments is provided to enable a person skilled in the art to make and use the present invention. Moreover, various modifications to these embodiments will be readily apparent to those skilled in the art, and the generic principles and specific examples defined herein may be applied to other embodiments. Therefore, the present invention is not intended to be limited to the embodiments described herein but is to be accorded the widest scope as defined by limitation of the claims.

What is claimed is:

1. A substrate processing system comprising:
a substrate processing module configured to process a substrate;
a bubble generation device configured to generate bubbles from a gas-dissolved liquid supplied to the substrate processing module; and
a control device configured to control an operation of the bubble generation device, wherein the substrate processing module comprises a supply nozzle configured to supply the gas-dissolved liquid,
wherein the bubble generation device comprises:
a supply line connected to the supply nozzle;
a boost pump configured to boost a pressure of a liquid flowing through the supply line;
a gas-dissolved liquid generation device configured to dissolve a gas in the liquid flowing through the supply line to a supersaturated state;
a pressure regulator configured to regulate a pressure of the gas supplied to the gas-dissolved liquid generation device; and
a decompression structure configured to generate ultra-fine bubbles from the gas-dissolved liquid generated by the gas-dissolved liquid generation device, and
wherein the control device is configured to control at least one of the pressure regulator and the boost pump so that the pressure of the gas supplied to the gas-dissolved liquid generation device is smaller than the pressure of the liquid supplied to the gas-dissolved liquid generation device.

2. The substrate processing system according to claim 1, wherein the decompression structure has:
a liquid inlet surface through which the gas-dissolved liquid flows in;
a liquid outlet surface through which the gas-dissolved liquid flows out; and
a liquid throttle surface arranged between the liquid inlet surface and the liquid outlet surface, and
wherein each of cross-sectional areas of the liquid inlet surface and the liquid outlet surface is larger than a cross-sectional area of the liquid throttle surface.

3. The substrate processing system according to claim 1, wherein the decompression structure is made of a grounded conductive resin.

4. The substrate processing system according to claim 1, wherein the decompression structure comprises a decompression membrane configured to reduce a pressure of the gas-dissolved liquid.

5. The substrate processing system according to claim 1, wherein the supply line has:
an upstream portion arranged upstream of the decompression structure in a flow direction of the gas-dissolved liquid; and
a downstream portion arranged downstream of the decompression structure, and
wherein at least one of the upstream portion and the downstream portion is made of a grounded conductive resin.

6. The substrate processing system according to claim 1, wherein in a case in which the decompression structure is defined as a first decompression structure, the bubble generation device comprises a second decompression structure configured to generate microbubbles from the gas-dissolved liquid generated by the gas-dissolved liquid generation device.

7. The substrate processing system according to claim 6, wherein:
the supply line has a first bypass line and a second bypass line arranged in a middle of the supply line;
the first decompression structure is connected to the first bypass line; and
the second decompression structure is connected to the second bypass line.

8. The substrate processing system according to claim 6, wherein in a case in which the supply nozzle is defined as a first supply nozzle, the substrate processing module comprises:
the first supply nozzle; and
a second supply nozzle configured to supply the gas-dissolved liquid,
wherein the supply line has:
a first branch line connected to the first supply nozzle; and
a second branch line connected to the second supply nozzle,
wherein the first decompression structure is connected to the first branch line, and
wherein the second decompression structure is connected to the second branch line.

9. A decompression structure applicable to a bubble generation device for generating bubbles from a gas-dissolved liquid supplied to a substrate processing module, comprising:
wherein the decompression structure has:
a main body portion connected to a supply line through which the gas-dissolved liquid flows; and
a wall portion attached to the main body portion and having an opening, and
wherein the wall portion is made of a grounded conductive resin.

10. The decompression structure according to claim 9, wherein the main body portion is made of a conductive resin and is an integrally molded member with the wall portion.

11. The decompression structure according to claim 9, wherein the opening is formed in a central portion of the wall portion.

12. The decompression structure according to claim 9, wherein the opening is formed in a connection portion of the wall portion with the main body portion.

13. The decompression structure according to claim 12, wherein the wall portion has a protrusion formed in a central portion of the wall portion, and
wherein the protrusion extends parallel to the main body portion.

14. The decompression structure according to claim 13, wherein the protrusion has a cylindrical shape.

15. The decompression structure according to claim 13, wherein the protrusion has a conical shape.
